(19) United States
(12) Patent Application Publication
(10) Pub. No.: US 2002/0197058 A1
(43) Pub. Date: Dec. 26, 2002

(54) Recording apparatus

(76) Inventors: Koichiro Suzuki, Kanagawa (JP); Nobutoshi Takayama, Kanagawa (JP)

Correspondence Address: FITZPATRICK CELLA HARPER & SCINTO, 30 ROCKEFELLER PLAZA, NEW YORK, NY, 10112, US

(21) Appl. No.: 10/152,829

(22) Filed: May 23, 2002

(30) Foreign Application Priority Data
May 28, 2001 (JP) 158533/2001 (PAT.
May 28, 2001 (JP) 158534/2001 (PAT.

(51) Int. Cl. H04N 5/76; H04N 5/225

(52) U.S. Cl. 386/69; 386/117

(57) ABSTRACT

A recording apparatus automatically selects a play list from among a plurality of play lists representing the reproduction procedures for the image data recorded on the recording medium, when the recording of image data on a recording medium is halted, and that changes the reproduction procedures in the selected play list so that the image data for which the recording is halted is reproduced.

### BACKGROUND OF THE INVENTION

1. Field of the Invention

The present invention relates to a recording apparatus and a recording method, and in particular to the processing for play-list data indicating reproduction procedures.

2. Related Background Art

A video camera is proposed that records digital image or audio data on a disk medium, such as an optical disk. For such a video camera that uses a disk medium, in view of a random access property thereof, a function has also been considered which can attains the reproduction, in a desired order, of arbitrary data recorded on a disk, by referring to a play list file in which is written a reproduction program designating the procedures of reproduction of recorded data.

Then, with a plurality of play lists, data recorded on the same disk can be reproduced in different orders.

In order to freely assemble favorite scenes from among images recorded on a single disk and create a play list indicating a desired reproduction order, the user must set an IN point and an OUT point for the clips of arbitrary scenes to obtain a desired reproduction program, while reproducing and monitoring data read from the disk.

The play list function can also be employed to automatically reproduce only scenes that match desired purposes (applications or conditions). However, for this process, the user must edit the play list while confirming images reproduced from the disk.

The play list function is very convenient. However, for ordinary users who are not familiar with the editing operation, it is very difficult to edit a play list while viewing images that are reproduced from the disk.

Furthermore, since a video camera is mainly employed to photograph images or to reproduce recorded images, when the play list function is implemented, it is important that operability of the camera be maintained, and as a result, a demand exists for a user interface that can be easily controlled by an ordinary user.

### SUMMARY OF THE INVENTION

It is one objective of the present invention to resolve the above described shortcomings.

It is another objective of the present invention to provide a simple operation with which a user can easily generate a desired play list.

It is an additional objective of the present invention to fully utilize the play list function.

To achieve these objectives, according to an aspect of the present invention, a recording apparatus comprises:

recording means for recording image data on a recording medium; and

play list control means for, when the recording of the image data by the recording means is halted, allocating the image data for which recording is halted, to a play list selected from among a plurality of play lists describing the reproduction procedures of image data recorded on the recording medium.

The other objectives and features of the present invention will become apparent during the course of the detailed description of the preferred embodiment, given while referring to the following drawings.

### BRIEF DESCRIPTION OF THE DRAWINGS

FIG. 1 is a diagram showing the configuration of a camera recorder according to the present invention;

FIG. 2 is a diagram showing the configuration of a recording circuit;

FIG. 3 is a diagram showing the configuration of a reproduction circuit;

FIG. 4 is a diagram showing the configuration of an editing circuit;

FIG. 5 is a diagram showing the configuration of a camera recorder according to the present invention;

FIG. 6 is a diagram showing the operating state of the camera recorder;

FIG. 7 is a diagram showing a play list menu;

FIG. 8 is a diagram showing, on a display, an image that is currently being photographed;

FIG. 9 is a diagram showing an image on a display after recording is halted; and

FIG. 10 is a diagram showing procedures for registration on a play list.

### DETAILED DESCRIPTION OF THE PREFERRED EMBODIMENTS

The preferred embodiments of the present invention will now be described.

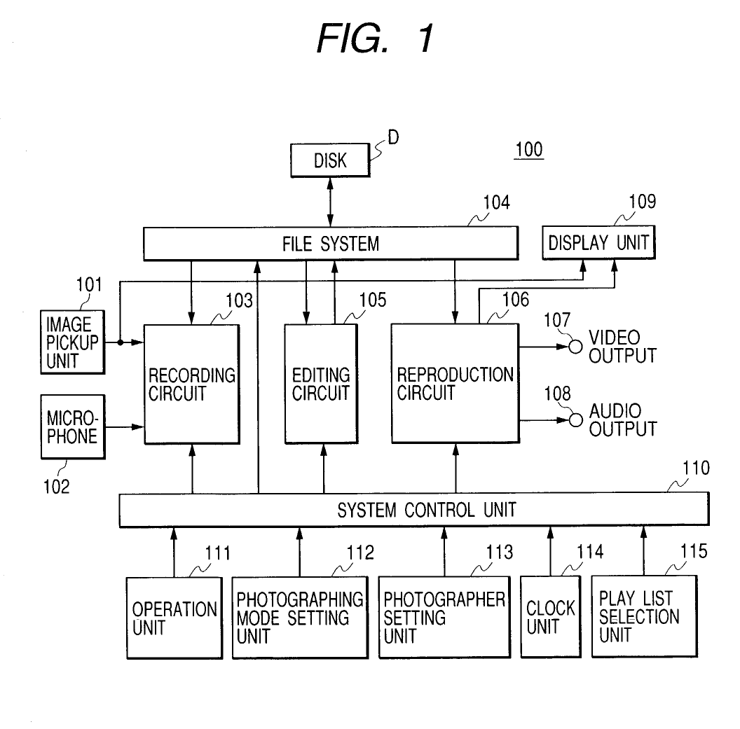

FIG. 1 is a block diagram showing the configuration of a video camera recorder 100 according to the present invention.

In FIG. 1, the video camera recorder 100 comprises: an image pickup unit 101; a microphone 102; a recording circuit 103 for compressing and encoding image and audio data obtained using the image pickup unit 101 and the microphone 102 respectively; a file system 104 for formatting, in a predetermined form, data output by the recording circuit 103 and for recording the resultant file data on or reproducing them from a magneto-optical disk D; an editing circuit 105 for processing a play list file that will be described later; a reproduction circuit 106 for reproducing a data file using the file system 104; image data and audio data output terminals 107 and 108; and a display unit 109 for displaying images related to image data that are output by the image pickup unit 101 and the reproduction circuit 106.

The video camera recorder further comprises: a system control unit 110 for controlling the operation of the camera recorder 100; an operation unit 111 which includes a power switch, a recording trigger, a reproduction switch, and a halt switch or a play list editing switch; a photograph mode setting unit 112 for setting a photographic mode; a photographer setting unit 113; a clock unit 114 for generating information for the current date; and a play list selection unit 115 for selecting, from among multiple play lists, a play list that is to be reproduced in a reproduction mode.

The operation for the normal recording mode will now be described.

When the recording mode is set by using the operation unit 111 and a recording start is instructed by the recording trigger, the system control unit 110 controls the recording circuit 103 to begin recording. The recording circuit 103 encodes image data and audio data obtained using the image pickup unit 101 and the microphone 102 respectively, and outputs the encoded data to the file system 104 in a predetermined form. The file system 104 formats a data string output by the recording circuit 103, by adding additional information, such as a header that conforms with a predetermined file form, and then records the formatted data on the disk D.

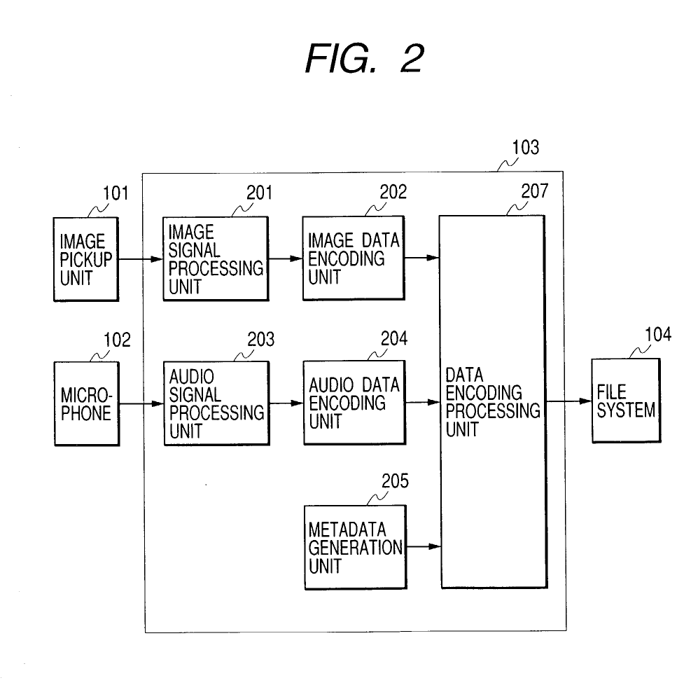

FIG. 2 is a diagram showing the arrangement of the essential portion of the recording circuit 103 and its peripheral circuit.

In FIG. 2, the image pickup unit 101 outputs image data to an image signal processing unit 201. The image processing unit 201 performs, on the image data received from the image pickup unit 101, a process such as sub-sampling in conformity with an encoded format, and outputs the resultant data to an image data encoding unit 202. In accordance with the MPEG2 standards, the image data encoding unit 202 encodes the image data received from the image signal processing unit 201 and outputs the encoded data to a data encoding processing unit 207.

The audio data obtained through the microphone 201 is output to an audio signal processing unit 203, whereat the audio data received from the microphone 102 is converted into digital data. Further on the digital data, the audio signal processing unit 203 performs a process, such as noise reduction or amplification, and outputs the resultant data to an audio data encoding unit 204. Thereafter, the audio data encoding unit 204 encodes the audio data received from the audio signal processing unit 203 in accordance with the MPEG2 standards, and outputs the encoded audio data to a data encoding processing unit 207.

At the data encoding processing unit 207, the encoded image data and the encoded audio data are converted into an MPEG transport stream that is output to the file system 104.

A metadata generation unit 205 generates metadata designating a photograph mode, a photograph date and a photographer, that will be described later, and outputs the metadata to the data encoding processing unit 207. The data encoding processing unit 207 arranges the metadata as the header or the footer of a file of image and audio data, and outputs the file to the file system 104.

In this embodiment, during a period extending from the time the recording start is triggered to the time the recording halt is triggered, the camera recorder 100 records, as a single file, the photographic image data and the audio data that are inputted. The data encoding processing unit 207 stores in the header or the footer of each file the metadata received from the metadata generation unit 205 and the thumbnail image data received from the image data encoding unit 202. In addition to these data, a file name is also recorded in the header.

The normal reproduction processing will now be described.

When a reproduction mode is established by using the operation unit 111, the system control unit 110 controls the reproduction circuit 106 to display, on the display unit 109, the thumbnail image of a data file that is recorded on the disk D. The user then confirms the thumbnail on the display unit 109, and manipulates the operation unit 111 to select a desired file to be reproduced. After the file to be reproduced is designated, the system control unit 110 controls the reproduction unit 106 to reproduce the data for the designated file.

The reproduction unit 106 reproduces the file designated by the file system 104, decodes the image data and the audio data in the reproduced file, outputs the decoded data to the output terminals 107 and 108, and also displays the reproduced image on the display unit 109. At this time, when the display of the metadata is instructed using the operation unit 111, the system control unit 110 controls the reproduction circuit 106 to display on the display unit 109 the metadata of the file currently being reproduced.

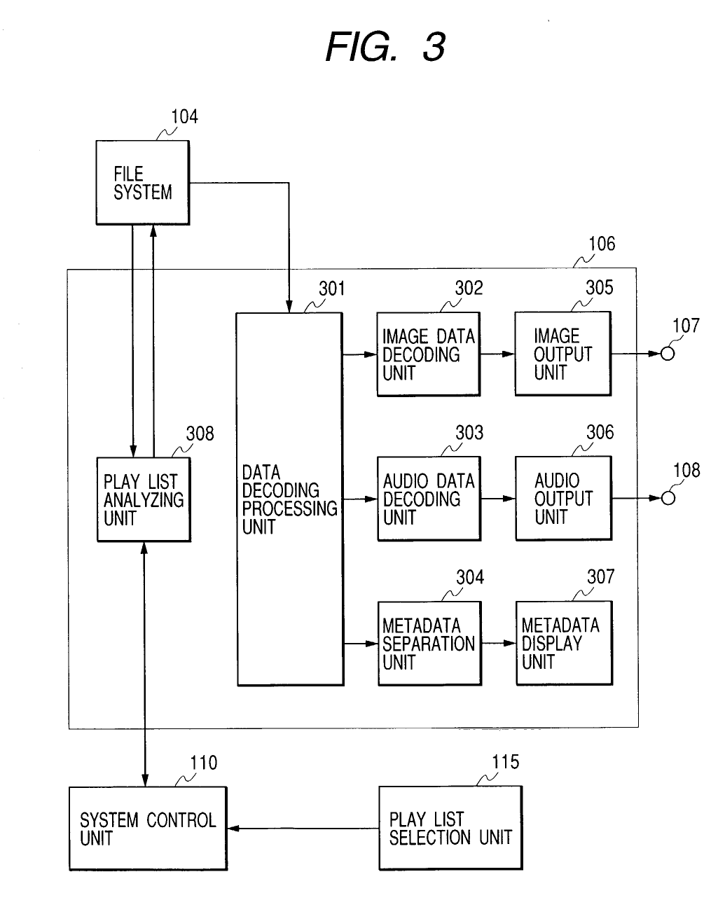

FIG. 3 is a diagram showing the configuration for the reproduction circuit 106 and its peripheral circuit.

In FIG. 3, the data reproduced by the file system 104 is output to a data decoding processing unit 301, which thereafter detects the image and audio data in the reproduced data string and the metadata stored in the header or the footer of the file. Then, the data decoding processing unit 301 outputs the image data to an image data decoding unit 302, and the audio data to an audio data decoding unit 303. The data decoding processing unit 301 also outputs the metadata to a metadata separation unit 304.

The audio data decoding unit 302 decodes the image data received from the data decoding processing unit 301, and outputs the decoded image data to an image output unit 305, whereat the image data is converted into an appropriate form for processing by an external monitor or another external device. The output unit 305 then outputs the image data to the output terminal 107 and the display unit 109.

At the audio data decoding unit 303 the audio data received from the data decoding processing unit 301 is decoded and transmitted to an audio output unit 306, whereat the received audio signal is converted into an appropriate form for processing by an external device and the resultant signal is transferred to the output terminal 108.

The metadata separation unit 304 detects the metadata contained in the data output by the data decoding processing unit 301, and outputs the metadata to a metadata display unit 307.

The play list function for this embodiment will now be described.

A play list is data describing the procedures of reproduction of data recorded on the disk D, as previously described, and is written using a description language, such as the SMIL (Synchronized Multimedia Integration Language).

In this embodiment, a plurality of play lists are prepared or created in accordance with the contents or the types of data that are to be reproduced. Thus, when a photography session is completed, the photographic data that have currently been obtained are automatically allocated to play lists in accordance with the photographing conditions under which the data were acquired. And thereafter, to select a play list for reproduction, the user need merely refer to the desired contents or the type of data. As a result, a user can easily select for reproduction only that data he or she desires.

The play list types can be, for example, play lists for photographers, play lists for photography dates, or play lists for photographing conditions corresponding to the photographic modes available with the camera recorder. In this embodiment, each time the photographing (the recording) of one file is completed, a play list corresponding to the photographic conditions for the file is automatically detected, so that a play list is allocated for each file.

The play list processing that accompanies the photographic operation will now be described.

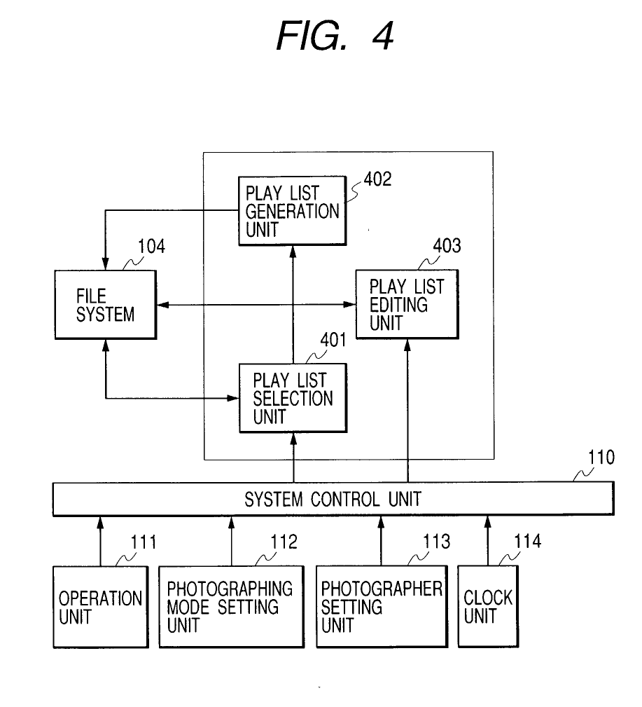

FIG. 4 is a block diagram showing the configuration for the editing circuit 105 and its peripheral circuit in FIG. 1.

First, after the camera recorder 100 is powered on and the recording mode is set, the system control unit 110 requests the display unit 109 to enter the name of the photographer. Then, the user employs the photographer setting unit 113 to designate the photographer's name, and the system control unit 110 stores this information in an internal memory.

Further, when the recording process is initiated, a photographing mode is set by the photographing mode setting unit 112. The available photographing modes include the same modes as those available with a well known camera recorder, and these, for example, are a standard mode, a portrait mode, a sports mode, a scenery mode and a surf-and-snow mode. The system control unit 110 controls the individual sections to perform the photographing in accordance with the designated photographing mode, and stores the information of the designated photographing mode in the internal memory.

When the photographing is performed according to above-described setting of the photographing mode and the operation unit 111 is used to input an instruction to halt the recording, the system control unit 110 controls the recording circuit 103 to halt the data recording and the editing circuit 105 to start the play list processing.

In FIG. 4 the system control unit 110, upon receiving the recording halt instruction, outputs to a play list selection unit 401 the information concerning the photographer and the photographing mode, both of which are stored in the internal memory, and information concerning the current date which is obtained from the clock unit 114. Then, the play list file is formed using the header in which the file name is written, the written data and the footer. Upon receiving these data from the system control unit 110, the play list selection unit 401 controls the file system 104 to reproduce and input the information for play lists stored on the disk D. Then, the play list selection unit 401 determines whether a play list corresponding to the photographer, the photographing mode and the photographing date, which are received from the system control unit 110, is included in the input play lists.

Assuming that play lists for photographers A and B are already recorded on the disk D and that the current photographer is B, the play list selection unit 401 controls the file system 104 to reproduce the play list related to the photographer B from the disk D, and output the reproduced play list to a play list editing unit 403.

Further, assume that play lists for the standard photographing mode and the portrait mode are already recorded on the disk D, but that the current photographing mode is the sports mode, then no play list corresponding to the sports mode exists on the disk D.

In this case, the play list selection unit 401 controls a play list generation unit 402 to generate a new play list for the sports mode, and the file system 104 to record the new play list on the disk D. The play list selection unit 401 then reproduces the new play list for the sports mode, and outputs a control signal to the file system 104 to transmit the reproduced play list to the play list editing unit 403.

In the same fashion, the play list selection unit 401 selects a play list for the current photographing date and outputs that play list to the play list editing unit 403.

Next, the system control unit 110 controls the play list editing unit 403 to add a currently obtained data file to the play lists that are already selected and read out by the play list selection unit 401. Specifically, the system control unit 110 determines reproduction procedures and rewrites the contents of the play list so as to reproduce the added data file subsequently to the latest data file among data files that are already designated to be reproduced in the selected play list.

After the play list editing unit 403 changes the contents of the individual play lists, the unit 403 outputs these play lists to the file system 104, which then records these play lists as independent files on the disk D.

As is described above, according to this embodiment, when the photographing by the user is halted, play lists associated with the photographing data are automatically selected, and the contents of the play lists are changed so as to add the new photographic data to the selected play lists. Then, when a play list associated to photographer A, for example, is selected from among the thus changed play lists to instruct reproduction, only the photographic data on the disk D obtained by the photographer A can be automatically reproduced.

The reproduction function that uses the play lists will now be described.

When the user sets the reproduction mode and then instructs the display of all the play lists by using the operation unit 111 in FIG. 1, the system control unit 110 outputs a control signal to a play list analyzing unit 308 in FIG. 3 to display of the play list information.

The play list analyzing unit 308 then issues an instruction to the file system 104 to reproduce all the play list files in the disk D, and stores the reproduced files in the internal memory. Thereafter, the play list analyzing unit 308 analyzes the contents of the play list files and displays on the display unit 109 information concerning the individual play lists.

When the play list information is displayed on the display unit 109, the user employs a play list selection unit 115 in FIG. 3 to select a play list for reproduction.

Subsequently, after a play list is selected by the user, the system control unit 110 outputs a control signal to the play list analyzing unit 308 to reproduce data in accordance with the selected play list. The play list analyzing unit 308 then analyzes the contents of the selected play list, and controls the file system 104 to reproduce a data file from the disk D in accordance with the description contents of the play list.

Thereafter, the file system 104 reproduces data in accordance with an instruction received from the play list analyzing unit 104, decodes the image data and audio data that are reproduced by the reproduction unit 106 in the same manner as in the normal reproduction operation, and outputs the decoded data.

Then, when the play list files concerning the photographers A and B and the play list files concerning the standard photographing mode, the portrait mode and the sports mode are already recorded on the disk D as is described above, the user need only select a desired play list, e.g., need only perform a simple operation to select a play list file concerning the photographer A and instruct the reproduction thereof, so that only data concerning the photographer A is automatically reproduced.

As is described above, according to this embodiment, when the photographing performed to produce image data and audio data is completed, the play list file corresponding to the photographing condition of the image data and the audio data is automatically selected, and information relative to the reproduction instruction of the currently obtained data is added to the selected play list file. Thus, after the photographing is completed, the user need not generate a play list file while reproducing the recorded data.

Therefore, the play list function of the camera recorder can very effectively be utilized.

In this embodiment, the present invention is applied to a video camera recorder. However, the present invention can also be variously applied to an apparatus employing a random access medium, such as a memory card, or another apparatus that includes the play list function, and the same effects can be obtained.

The data files that are automatically added to the play lists when the photographing is completed are reproduced in the order corresponding to the dates on which the play list files are photographed. However, the user can easily change this reproduction order only by changing the contents of the play lists. Furthermore, those play list files that are automatically generated, or that are added or edited, can also be arbitrarily changed thereafter.

In addition, by providing a small GPS, for example, a photographing location may be detected, as well as the photographer, the photographing mode and the photographing date, and a play list may be generated that is associated with the location at which the photographing is performed. Further, a play list may be generated in accordance with the length (continuous photographing period) of a file, or a satisfaction level entered arbitrarily by a user.

A second embodiment of the present invention will now be described.

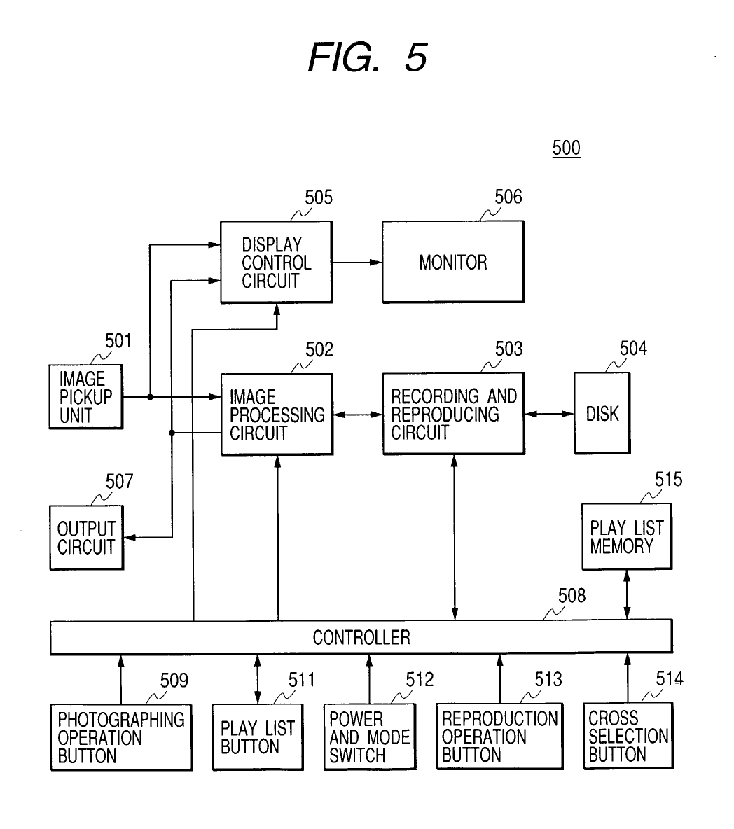

FIG. 5 is a block diagram illustrating the configuration of a video camera recorder 500 according to the second embodiment of the present invention.

In FIG. 5, the video camera recorder 500 comprises: an image pickup unit 501; an image processing circuit 502 for encoding or decoding image data; a recording and reproducing circuit 503 for recording data on or reproducing data from. a magnetooptical disk 504, such as a DVD-RAM disk; and a display control circuit 505 for controlling the display of an image on a monitor 506, such as a liquid crystal panel.

The video camera recorder 500 further comprises: a controller 508 for controlling the individual sections of the camera recorder 500; a photographing operation button 509 which becomes effective in a camera mode and includes a photo key used for recording a static image and a trigger key for recording a moving image; a play list button 511 which includes internally an LED; a power and mode switch 512 for the camera recorder 500; a reproduction operation button 513 which includes five keys, i.e., stop, reproduce, plus search, minus search and pause keys; a cross selection button 514 which is used to control a menu or to select a play list that will be described later; and a play list memory 515 in which either a play list reproduced from the disk 504 or a newly generated play list is stored.

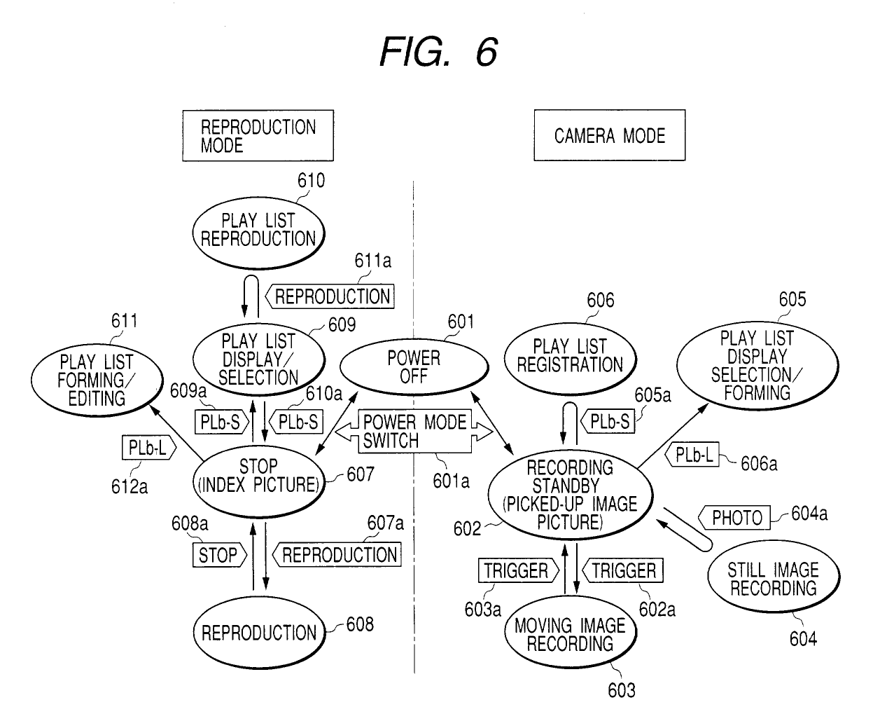

FIG. 6 is a diagram showing the shifting of the operating state accompanied by the manipulation of each key of the camera recorder 500 in FIG. 5. In FIG. 6, operating states 601a to 612a represent operations performed by selecting the individual keys and buttons in FIG. 5. Operating states 601 to 611 are those shifted by these key manipulations, and arrows between the states indicate the directions of the shifts that accompany the key manipulations. A U-turn arrow, for example, represents a condition wherein a changed state is returned automatically to its original state.

The recording and reproduction operation of the camera recorder 500 in FIG. 5 will now be described while referring to FIG. 6.

First, the normal recording operation will be explained.

When the power mode switch 512 is manipulated in the state 601 wherein the power is off, the camera recorder 500 can be set either to the photographing camera mode or to the reproduction mode for reproducing images recorded on the disk 504. The power mode switch 512 is a three-position, sliding type switch that enables a user to directly shift the camera recorder 500 from the power-OFF state to the camera mode or the reproduction mode.

When the camera mode is set, the camera recorder 500 is shifted to the recording standby state 602, and the controller 508 controls the display control circuit 505 to display, on the monitor 506, an image output by the image pickup circuit 501. When the trigger operation 602a is performed in this state, the camera recorder 500 is shifted to the moving image recording state 603, and the controller 508 controls the image processing circuit 502 and the recording and reproducing circuit 503 to initiate the recording of image data.

In accordance with the MPEG2 standard, the image processing circuit 502 encodes the moving image data received from the image pickup unit 503, and outputs to the recording and reproducing circuit 503, the encoded data of the MPEG2 transport stream format. The recording and reproducing circuit 503 adds a header, including a file name and other additional information, to the data string received from the image processing circuit 502, converts the resultant data into a predetermined format, and records the converted data on the disk 504.

When the trigger key operation 603a is again performed in the moving image recording state 603, the controller 508 controls the image processing circuit 502 and the recording and reproducing circuit 503 to halt the recording of image data, and the camera recorder 500 is returned to the recording standby state 602.

Upon the reception by the controller 508 of a recording halt instruction, the recording and reproducing circuit 503 adds a predetermined footer to the data string received from the image processing circuit 502 and halts the recording onto the disk 504. In this embodiment, a series of moving image data from the recording start by the trigger key operation 602a to the recording stop by the trigger key operation 603a is recorded as a single file on the disk 504.

The recording of a still image will now be described.

When the photo key operation 604a is performed in the recording standby state 602, the camera recorder 500 is shifted to the static image recording state 604 and the controller 508 controls the image processing circuit 502. In accordance with a still image recording instruction received from the controller 508, the image processing circuit 502 extracts one frame from image data received from the image pickup circuit 501, encodes the frame in accordance with the JPEG standards, and outputs the encoded data to the recording and reproducing circuit 503. Thereafter, the recording and reproducing circuit 503 adds a predetermined header or footer to the encoded still image data, generates a file conforming with a predetermined format, and records the file on the disk 504.

When the recording of still images is completed, as is shown in FIG. 6, the camera recorder 500 is automatically returned to the recording standby state 602.

The processing related to the play list in the camera mode will now be described.

In this embodiment, the play list button 511 is effective in either the camera mode or the reproduction mode, and the controller 508 can identify two operations: a short operation PLb-s with the performance time which is within one second, and a long operation PLb-L with the performance time which exceeds one second. Further, the play list button 511 is so arranged on the main body of the camera recorder 500 that it can be easily manipulated either in the camera mode or in the reproduction mode.

When the long operation 606a of the play list button 511 is performed in the recording standby state 602 in FIG. 6, the camera recorder 500 is shifted to the play list display state 605.

Specifically, when the long operation 606a of the play list button 511 is performed in the recording standby state 602, the controller 508 first controls the recording and reproducing circuit 503 to reproduce all the play list files recorded on the disk 504, and stores the reproduced play list files in the play list memory 515. Then, the controller 508 examines the contents of the play list files and controls the display control circuit 505 to display, on the monitor 506, a menu indicating the list of the play list files reproduced from the disk 504.

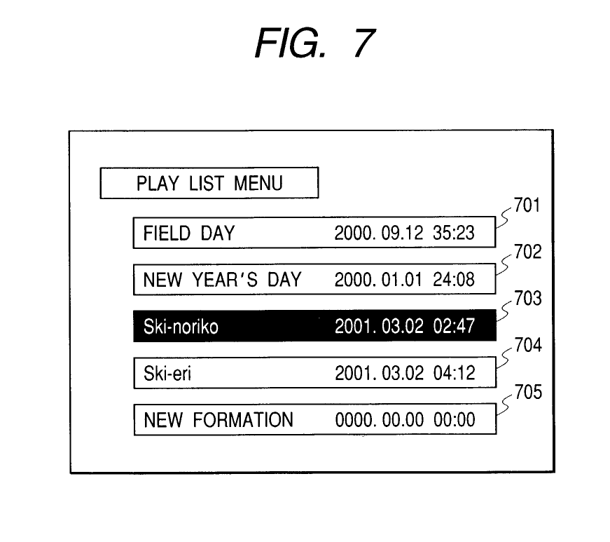

FIG. 7 is a diagram showing a play list menu displayed on the monitor 605 in the play list display state 605. In FIG. 7, the menu indicates that four play list files 701 to 704 are recorded on the disk 504, and the titles, update dates and reproduction times for these play lists are also displayed.

A user can refer to the menu screen of the play list files, and can manipulate the cross section key 514 to select in advance a desired play list file in which photograph data to be obtained should be registered. In FIG. 7, of the four play list files 701 to 704, the third play list file 703, which has the title “Ski-noriko”, is selected.

Further, to create a new play list file, instead of selecting a play list file that is already recorded on the disk 504, a user may select the new formation 705. When this selection is made, the controller 508 controls the display control circuit 505 to display a title input screen (not shown) on the monitor 506. For this title input screen, the user can add a desired title, and at this time, if the user adds a title with which the user can associate an image file to be registered on the play list file, files can be easily sorted when the user registers an additional image file later.

Furthermore, while the play list menu is being displayed, the controller 508 causes light to be emitted by an LED incorporated in the play list button 511, so that the user, by glancing at the button, can be notified that the play list file is selected.

When the play list file is selected in advance from the menu in FIG. 7, the controller 508 deletes the play list file menu screen and displays on the display 506 an image obtained from the image pickup circuit 501, while the camera recorder 500 is automatically shifted to the recording standby state 602.

An explanation will now be given for the processing performed to record moving image data or static image data after the play list file is selected in the above described manner.

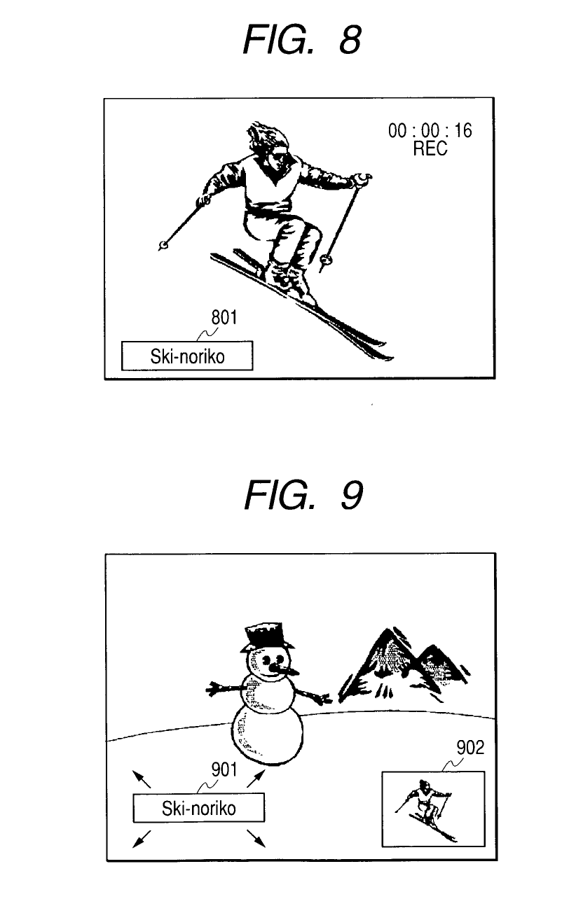

The recording is initiated in the same way as for normal recording processing. Then, in case that the play list file is already selected in the play list display and selection operation 605, the controller 508 controls the display control circuit 505, during the recording of image data, to synthesize with image data output by the image pickup circuit 501 the information 801 in FIG. 8 that refers to the title of the currently selected play list file, and to display the synthesized data on the monitor 506. As a result, while photographing, the user can always confirm a currently selected play list file.

When the camera recorder 500 is shifted to the recording standby state 602 by the trigger key operation 603a, the controller 508 controls the display control circuit 505, as is shown in FIG. 9, to blink a title 901 of a currently selected play list file for a predetermined period of time (about five to ten seconds), and to thereafter delete the title 901. In addition, at this time a last scene 902 of the data obtained by photographing is displayed on the monitor 506 as a still, reduced size image.

When the user desires to register a currently obtained image on a currently selected play list file, he or she performs the short operation 605a of the play list button 511 while the title 901 is blinking. And when the short operation 605a of the play list button 511 occurs within a predetermined period of time following the end of the photographing performed during the trigger key operation 203a, the controller 508 allocates for currently obtained image data file the selected play list file, “Ski-noriko” in this case, and registers the image data file on the play list file.

Furthermore, when the short operation 605a of the play list button 511 does not occur within the predetermined period of time following the end of the recording, the automatic registration is not performed on the selected play list file, and the camera recorder 500 is shifted to the recording standby state 602.

When the registration of the play list file is completed, the controller 508 erases from the monitor 506 the title 901-of the play list file and the reduced screen 902, and the camera recorder 500 is shifted to the recording standby state 602.

For the registration process performed herein, based on the play list file, the image file to be reproduced is automatically designated, and the reproduction procedure of the play list files is changed so as to reproduce the image file at a predetermined timing.

In this embodiment, the play list file is automatically created in accordance with SMIL, which is a computer description language. And as is described above, when the image data file is registered following the photographing, the play lists are generated so that they can be reproduced in the order in which they were registered.

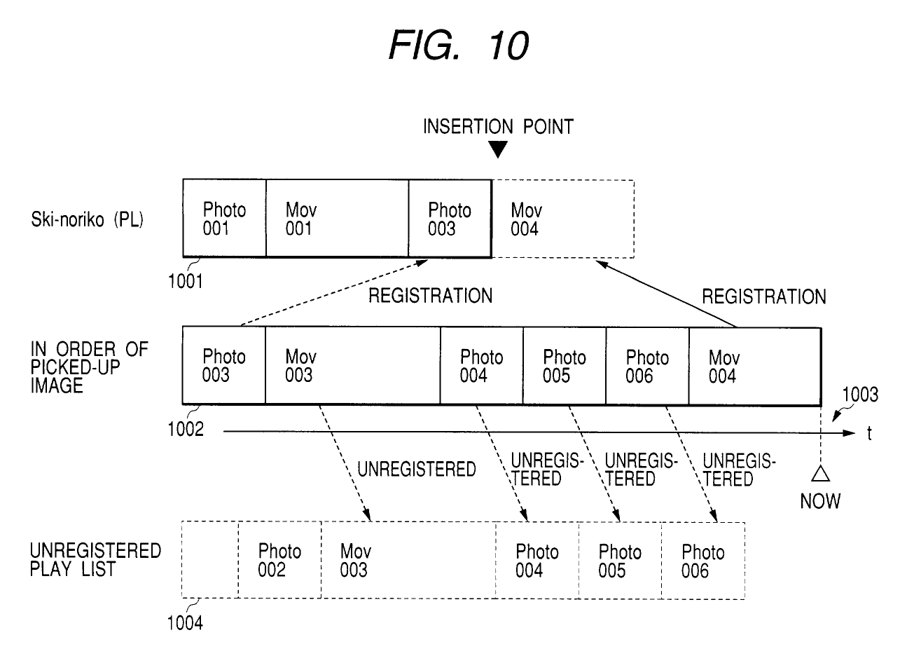

FIG. 10 is a diagram showing the automatic registration in a play list file of an image data file.

In FIG. 10, image data files are referred to by an automatic reproduction program written in a selected play list file 1001, “Ski-noriko”. Image data files 1002 are those recorded on a disk in accordance with a time series.

In FIG. 10, of the recorded data 1002, still image data file Photo003 is registered in the play list 1001, while image data files Mov003, Photo004, Photo005 and Photo006, which are obtained later, are not. Then, when the short operation of the play list button 511 is performed at a time 1003, whereat the moving image data Mov004 is recorded, the moving image data Mov004 can be registered on the play list 1001. During the reproduction process for the play list 1001, which will be described later, image data are reproduced in the order Photo0001, Mov001, Photo003 and Mov004.

Also, all the files 1002 in FIG. 10 can be registered on the play list 1001.

Furthermore, in this embodiment, an unregistered play list is automatically created, and of the data 1002 recorded on the disk 504, files not registered on the selected play list 1001, i.e., files Mov003, Photo004, Photo005 and Photo006, are automatically registered on the unregistered play list.

The unregistered play list is not displayed on the play list menu screen in FIG. 7 in the play list display and registration state 605. But when a predetermined operation is performed during the play list editing process, which will be described later, an operation related to the unregistered play list can be performed. Specifically, a function can be easily implemented for erasing from the disk 504 all of the data registered in the unregistered play list.

In addition, in this embodiment, during a period from time when in the power-OFF state 601, the camera mode is set by the manipulation of the power and mode switch 512 and to time when the camera mode is then shifted to the reproduction mode or back to the power-OFF state 601, only the registered play list in the latest camera mode is regarded as effective.

That is, when the camera recorder 500 is shifted from the camera mode to the power-OFF state 601 and then is set back to the camera mode, all of the unregistered play list contents that currently are stored are deleted, and new registration of an unregistered play list is performed.

As is described above, when the automatic registration of the play list file is completed and then in the recording standby state 602 the power and mode switch 512 is manipulated to instruct a shift to the power-OFF state 601 or to the reproduction mode, the controller 508 controls the recording and reproducing circuit 503 to read out a play list file from the play list memory 515, and to record the read-out play list file on the disk 504. It should be noted that the contents of the play list file that is to be recorded are, of course, altered through the above described registration process.

Subsequently, when the recording of the play list file is completed, the camera recorder 500 is shifted to the reproduction mode or to the power-OFF state 601.

The processing performed during the reproduction mode will now be described.

First, the normal reproduction processing will be described.

When the reproduction mode is set by the operation 601a of the power and mode switch 512, the camera recorder 500 is shifted to the stop state 607. In the stop state 607, the controller 508 controls the recording and reproducing circuit 505 to reproduce TOC data recorded in a predetermined area on the disk 504, and to store the reproduced TOC data in the internal memory. The TOC data is information concerning recorded data, such as the recording locations and the types of data recorded on the disk 504, the periods of time required for the recordings and the file names. The TOC data further includes image data representing a reduced image (a thumbnail image) for each moving image file and each still image file.

The controller 508 detects the thumbnail image data in the reproduced TOC data, and outputs the detected data to the display control circuit 505. Further, the controller 508 controls the display control circuit 505 to display on the monitor 506 an index screen showing a list of the thumbnail images that represent the multiple image files recorded on the disk 504.

When a user manipulates the cross selection key 514 to select a thumbnail image representing a desired file, and manipulates the reproduction key of the reproduction operation button 513, the camera recorder 500 is shifted to the reproduction state 608 by the reproduction key operation 607a.

In the reproduction state 608, the controller 508 employs the TOC data to detect the recording location of a selected data file. The controller 508 then controls the recording and reproducing circuit 503 to reproduce the selected data from the disk 504. The recording and reproducing circuit 503 detects an image data string in the reproduced disk 504 data, and outputs the detected image data string to the image processing circuit 502.

Thereafter, the image processing circuit 502 decodes the received image data string and outputs the decoded image data to the display control circuit 505 and the output circuit 507. The controller 511 then controls the display control circuit 505 to display on the monitor 506 an image related to the reproduced image data. Following this, the output circuit 507 converts the image data received from the image processing circuit 502 into data of a format appropriate to an external device, such as a monitor, and outputs the obtained image data.

When the stop key operation 608a of the reproduction operation button 513 is performed in the reproduction state 608, the camera recorder 500 is set back to the stop state 607.

The reproduction processing using the play list will now be described.

When the short operation 609a of the play list button 511 is performed in the stop state 607, the camera recorder 500 is shifted to the play list display and to selection state 609.

Specifically, when the short operation 609a of the play list button 511 is performed in the stop state 607, the controller 508 controls the recording and reproduction circuit 503 to reproduce a play list file recorded on the disk 504, and to store the reproduced play list file in the play list memory 515. The controller 508 then controls the display control circuit 505 to display on the monitor 506 the same play list menu as was displayed in the play list display and selection state 605. However, in this case, the new formation 705 in FIG. 7 is not displayed; only display for play list files recorded on the disk 504 is performed.

A user can select a desired play list file from the play list menu in FIG. 7 by manipulating the cross selection key 514. Then, after the play list file is selected, the reproduction key operation 611a of the reproduction operation button 513 is used to shift camera recorder 500 to the play list reproduction state 610.

That is, in the play list reproduction state 610, the controller 508 identifies the contents of a play list file selected from the play list memory 515. The controller 508 then controls the recording and reproducing circuit 503 to reproduce data recorded on the disk 504 in the above described manner, and to output the reproduced data to the image processing circuit 502. Thereafter, the image processing circuit 502 decodes the reproduced image data and outputs the decoded image data to the display control circuit 505 and the output circuit 507. During the reproduction performed using the play list, the images reproduced in accordance with the play list are displayed.

When reproduction of the data described in the play list file is completed, the camera recorder 500 is automatically returned to the play list display and selection state 609, and the play list menu is displayed on the monitor 506. Then, when in the play list display and selection state 609 the short operation 610a of the play list button 511 is performed, the camera recorder 500 is returned to the stop state 607.

Finally, the processing performed to edit the play list file will be described.

When the long operation 612a of the play list button 511 is performed in the stop state 607, the camera recorder 500 is shifted to the play list creation and editing state 611. In the play list creation and editing state 611, the controller 508 controls the display control circuit 505 to display an editing screen. The user can then manipulate the cross selection key 514 to edit data to be registered in the play list file that is to be recorded on the disk 504. Further, in accordance with the above described unregistered play list, an image file that is not registered in any play list file can be searched for.

Specifically, upon receiving a search instruction, the controller 508 reproduces, from the disk 504, thumbnail image data for image files that are registered on the unregistered play list, and reduces and displays the reproduced thumbnail images on the monitor 506. After the list of the searched thumbnail images of the image files are displayed, all of these image files can collectively be deleted.

As is described above, following the reproducing in accordance with the play list file or the editing of the play list file is completed, the power and mode switch 512 is manipulated in the stop state 607 to instruct a shift to the power-OFF state 601 or to the camera mode. Then, the controller 508 controls the recording and reproducing circuit 503 to read out a play list file from the play list memory 515, and to record the read-out play list file on the disk 504.

When the recording of the play list file is completed, the camera recorder 500 is shifted either to the power-OFF state 601 or to the camera mode.

As is described above, according to the embodiments, before photographing is performed, a play list file to be registered is selected in advance from among a plurality of play list files recorded on a disk, and when the photographing of the images is completed, information for reproduction instruction of currently obtained data is added to the selected play list file. Therefore, a user need not create or edit a play list file later by reproducing data that is recorded on the disk.

Therefore, the play list function of the camera recorder can be utilized very effectively.

Furthermore, only the play list button 511 is employed to instruct to display the list of play list files before the photographing process or register, an image data file related to the play list file after the photographing process. Therefore, the operation is greatly simplified.

The same play list button 511 can also be employed to instruct the display of the list of play list files in the reproduction mode, and the setting of the play list file editing mode. Thus, the performance of the operation is facilitated.

In addition, since during the photographing the title of the selected play list file is displayed on the monitor, the user can always confirm the currently selected play list file.

Further, since the title of the play list file blinks after the photographing is completed, the user can easily be notified of an effective period for automatic registration. Furthermore, since the last picture of the currently obtained scene is displayed in a reduced size, it can assist the user in determining whether or not the currently obtained image should be registered in the selected play list file.

Moreover, the unregistered play list file is prepared, and after the photographing, only data files that are not registered in the play list file are automatically registered in the unregistered play list file. Thus, in the play list editing process in the reproduction mode, only image data that is not employed for the play list file can be collectively deleted.

In these embodiments, only one of the play list files is selected in the play list display and selection state 605. However, a plurality of play lists files can also be selected at the same time. Also in the embodiments, the user determines whether or not the currently obtained image data should be registered in the currently selected play list file. However, after the photographing is completed, the image data may be automatically registered.

Further, in the embodiments, after the photographing is completed, an image file that is newly registered in a play list file is reproduced at the last. However, a position in a selected play list file into which an image file that is obtained is to be inserted may be set up before the photographing is performed. In this case, in the play list display and selection state 605, data immediately preceding the insertion position in the play list file can be automatically reproduced, and can be displayed on a monitor.

Furthermore, after the play list file is selected, in the recording standby state 602, a predetermined manipulation, such as the manipulation of a reproduction operation button, may be performed so as to preview the last scene of an image that is designated in the selected play list file.

Moreover, image files registered in the unregistered play list may be deleted each time the photographing date is changed.

In the embodiments, the present invention is applied to a video camera recorder. However, the present invention can also be applied to an apparatus using a random access medium, such as a memory card, and another apparatus having a play list function, and the same effects can be obtained.

Further, the process for the registration in the play list, the play list editing process, the recording and reproduction process for an image data file, and the process for encoding and decoding image data may be implemented by a micro computer using a software program. In this case, a memory or a storage medium, such as a CD-ROM, on which the software program is stored also constitutes the present invention.

Many widely different embodiments of the present invention may be constructed without departing from the spirit and scope of the present invention. It should be understood that the present invention is not limited to the specific embodiments described in the specification, except as defined in the appended claims.

What is claimed is:

1. A recording apparatus comprising:
recording means for recording image data on a recording medium; and
play list control means for, when the recording of said image data by said recording means is halted, allocating said image data for which recording is halted, to a play list selected from among a plurality of play lists describing the reproduction procedures of image data recorded on said recording medium.

2. An apparatus according to claim 1, wherein said play list control means includes selection means for automatically selecting said play list when the recording of said image data is halted.

3. An apparatus according to claim 2, wherein said selection means is capable of selecting a plurality of play lists, and wherein said play list control means allocates said image data, the recording of which is halted, to all of said plurality of play lists that are selected.

4. An apparatus according to claim 2, wherein said selection means automatically selects said play list in accordance with the recording state of said image data.

5. An apparatus according to claim 2, further comprising:
condition setting means for setting a condition of the recording of said image data,
wherein said selection means automatically selects a play list in accordance with said condition designated by said condition setting means.

6. An apparatus according to claim 5, wherein said condition setting means includes mode switching means for switching the photographing mode of image pickup means for generating said image data.

7. An apparatus according to claim 2, wherein said selection means automatically selects a play list in accordance with the photographing condition of said image pickup means for generating said image data.

8. An apparatus according to claim 1, wherein said play list control means automatically generates a new play list in accordance with the recording state of said image data, and allocates to said new play list said image data for which recording is halted.

9. An apparatus according to claim 1, wherein said play list control means changes the reproduction procedures of said selected play list so that said image data for which recording is halted is reproduced in accordance with said selected play list, and wherein said recording means records on said recording medium said play list for which the reproduction procedures have been changed.

10. An apparatus according to claim 1, further comprising:
reproduction means for reproducing said image data from said recording medium,
wherein said play list control means controls said reproduction means to reproduce said image data using the reproduction procedures based on said play list.

11. A recording apparatus comprising:
recording means for recording image data on a recording medium;
selection means for selecting an any play list from among a plurality of play lists indicating reproduction procedures of said image data recorded on said recording medium; and
control means for, when the recording of said image data is halted, changing said reproduction procedures of said play list selected by said selection means so that said image data for which the recording is halted is reproduced.

12. A recording apparatus according to claim 11, further comprising:
instruction means for arbitrarily issuing an instruction to determine whether or not said reproduction procedures employed by said control means should be changed,
wherein, upon the reception of said instruction from said instruction means, said control means determines whether or not said reproduction procedures of said play list selected by said selection means should be changed.

13. A recording apparatus according to claim 12, further comprising:
display means; and
display control means for displaying on said display means a predetermined image for requesting an instruction from said instruction means, when the recording of said image is halted.

14. A recording apparatus according to claim 12, wherein said control means makes effective a change instruction that is issued by said instruction means, during a predetermined period following the halting of the recording of said image data.

15. A recording apparatus according to claim 14, wherein said control means displays, on said display means, a predetermined image for requesting an instruction from said instruction means, during said predetermined period following the halting of the recording of said image data, and deletes said predetermined image after said predetermined period elapses.

16. A recording apparatus according to claim 15, wherein said predetermined image is information indicating said selected play list.

17. A recording apparatus according to claim 11, further comprising:
search means for searching for image data that is recorded on said recording medium and for which the play list is not changed when the recording is halted.

18. A recording apparatus according to claim 17, further comprising:
deletion means for deleting, from said recording medium, said image data found by said search means.

19. A recording apparatus according to claim 17, wherein said play list control means generates an unregistered play list in order to reproduce only image data for which, when the recording is halted, the contents of a play list are not changed, and wherein said search means performs the search in accordance with said unregistered play list.

20. A recording apparatus comprising:
recording means for recording image data on a recording medium;
an operation unit which can be arbitrarily operated;
display means for, in accordance with a first operation of said operation unit, displaying on a display unit menu information for a plurality of play lists representing the reproduction procedures of image data recorded on said recording medium;
selection means for employing said menu information to select an arbitrary list from among said plurality of play lists; and
control means for, in accordance with a second operation performed by said operation unit within a predetermined period of time following the halting of the recording of said image data, changing the reproduction procedures represented in said play list selected by said selection means so that said image data for which the recording is halted is reproduced.

21. A recording apparatus according to claim 20, wherein said first operation is a continuous operation of said operation unit for a first time period or longer, and said second operation is a continuous operation of said operation unit for a time period less than said first period.

22. A recording apparatus according to claim 20, wherein said recording means records, on said recording medium, said play list in which the reproduction procedures is changed by said control means.

23. A recording apparatus according to claim 20, further comprising:
reproduction means for reproducing said image data from said recording medium,
wherein said control means controls said reproduction means to reproduce said image data in accordance with said reproduction procedures in said play list.

24. A recording apparatus according to claim 23, wherein said control means establishes an editing mode in which the reproduction procedures in said play list recorded on said recording medium is changed in accordance with said first operation of said operation unit.

25. An imaging apparatus comprising:
image pickup means;
recording means for recording, on a recording medium, image data obtained by said image pickup means;
reproduction means for reproducing said image data from said recording medium;
an operation unit that is arbitrarily operable;
mode switching means for switching between a photographing mode in which said recording means records said image data obtained by said image pickup means, and a reproduction mode in which said reproduction means reproduces said image data from said recording medium;
a display unit;
control means for controlling said display unit, in accordance with a first operation of said operation unit in a photographing wait state in said photographing mode or a second operation of said operation unit in a reproduction halt state in said reproduction mode, to display menu information for a plurality of play lists representing the reproduction procedures of image data recorded on said recording medium; and
selection means for, based on said menu information displayed on said display unit, selecting information concerning an arbitrary play list,
wherein, in said photographing mode, in accordance with said second operation of said operation unit following the halting of the recording of said image data by said recording means, said control means changes the reproduction procedures in a play list selected by said selection means so that said image data for which the recording is halted is reproduced; and wherein, in said reproduction mode, said control means controls said reproduction means to reproduce said image data in accordance with the reproduction procedures in said play list selected by said selection means.

26. An imaging apparatus according to claim 25, wherein said first operation is a continuous operation of said operation unit for a first period or longer, and said second operation is a continuous operation of said operation unit for a time period less than said first period.
